(19) United States
(12) Patent Application Publication
(10) Pub. No.: US 2018/0119832 A1
(43) Pub. Date: May 3, 2018

(54) INTEGRATED DISK CHECK VALVE IN A HYDRAULIC TENSIONER WITH METERED BACKFLOW

(71) Applicant: BorgWarner Inc., Aubum Hills, NY (US)

(72) Inventors: Matthew W. Crump, Cortland, NY (US); Glenn E. Swanson, Lansing, NY (US); Keith B. Cobb, Cortland, NY (US)

(21) Appl. No.: 15/573,739

(22) PCT Filed: May 5, 2016
(86) PCT No.: PCT/US16/30908

§ 371 Date: Nov. 13, 2017

Related U.S. Application Data
(60) Provisional application No. 62/161,619, filed on May 14, 2015.

(51) Int. Cl. F16K 15/02; F16H 7/08; F16K 27/02

(52) U.S. Cl. CPC F16K 15/028; F16H 7/0848; F01L 1/024; F16H 2007/0859; F16H 2007/0806; F16K 27/0209

(57) ABSTRACT

A check valve assembly (20) and method of assembly can include a hydraulic tensioner (10) having a body (12) defining an inlet fluid passage with an inlet fluid passage port (14a) having a valve seat (14b). The check valve assembly (20) can include a retainer (22) located within the body (12), a valve disk (30) having a sealing surface (32), and a biasing member (34) normally biasing the valve disk (30) toward the inlet fluid passage port (14a). The retainer (22) can define an outlet passage (24). The valve disk (30) and the biasing member (34) can be received within a cavity (26) of the retainer (22). The biasing member (34) can allow reciprocal movement of the valve disk (30) from a closed seated position sealing the inlet fluid passage port (14a) to an open unseated position spaced from the inlet fluid passage port (14a) opening the inlet passage.

### FIELD OF THE INVENTION

The invention relates to a check valve apparatus and method of manufacture, and more particularly to a hydraulic tensioner for applying proper tension to an endless, flexible, power transmission member, such as a timing belt or timing chain, encircling a driving sprocket and at least one driven sprocket as used for an internal combustion engine of a motor vehicle.

### BACKGROUND

There is a desire to provide a disk style check valve having a surface area acting directly on a body of a hydraulic tensioner to reduce the number of parts required in a check valve assembly.

### SUMMARY

Current hydraulic tensioners use a drop-in check valve assembly. A check valve assembly can be assembled directly into a body of the hydraulic tensioner in order to reduce the number of parts required in the check valve assembly. To overcome the limitation of current technology, a disk style check valve can have a larger contacting surface area acting directly on the tensioner body, eliminating the requirement of a mating component such as a valve seat. However, a mating component can be inserted to reduce wear associated with the disk style check valve acting directly on the tensioner body. Current check valve assemblies are mated to a plastic component forming either a seal with the tensioner body or vent if a metered backflow is required in the tensioner. The plastic component can be eliminated by using at least one orifice of a given size directly formed in the disk style check valve to deliver a metered backflow. The orifices can be formed in the disk style check valve through a stamping, or deep drawing process, with a secondary machining. Smaller diameters can be created through a water jet or laser cutting process. A metered backflow can be provided by forming, machining, or lasering a flow path or tortuous path on the bottom of the disk style check valve or on a mating component, which can be either the tensioner body or the inserted valve seat.

A hydraulic tensioner for an endless loop, flexible, power transmission member of an internal combustion engine of a motor vehicle can have a body defining an inlet fluid passage with an inlet fluid passage port having a valve seat and check valve assembly. The check valve assembly can include a retainer located within the body defining an outlet fluid passage in fluid communication with the inlet fluid passage through a cavity defined by the retainer. The check valve assembly can include at least one valve disk having at least one valve sealing surface and at least one biasing member received within the cavity for biasing the at least one valve disk toward the inlet fluid passage port. The at least one valve disk can be received within the cavity for reciprocal movement with respect to the inlet fluid passage port of the body and normally biased toward the inlet fluid passage port. The at least one biasing member can allow reciprocal movement of the at least one valve disk from a closed seated position sealing the inlet fluid passage port to an open unseated position spaced from the inlet fluid passage port opening the inlet fluid passage and allowing fluid flow through the inlet fluid passage.

A check valve assembly can include a hydraulic tensioner having a body defining a fluid passage in fluid communication with an inlet passage having an inlet fluid passage port. The check valve assembly can include a retainer located within the fluid passage of the hydraulic tensioner, at least one valve disk having at least one valve sealing surface directly engageable with the body of the hydraulic tensioner, and at least one biasing member. The retainer can define an outlet fluid passage in fluid communication with the inlet fluid passage through a cavity defined by the retainer. The at least one valve disk can be received within the cavity for reciprocal movement with respect to the inlet fluid passage port and normally biased toward the inlet fluid passage port. The at least one biasing member can be received within the cavity for biasing the at least one valve disk toward the inlet fluid passage port while allowing reciprocal movement of the at least one valve disk from a seated, closed position sealing the inlet fluid passage port to an open, unseated position spaced from the inlet fluid passage port allowing fluid flow through the inlet fluid passage port.

A hydraulic tensioner having a body defining an inlet fluid passage port can be assembled. The hydraulic tensioner can support a check valve assembly for an endless loop, flexible, power transmission member of an internal combustion engine of a motor vehicle. The method of assembling can include positioning a retainer within the body, the retainer defining an outlet fluid passage in fluid communication with the inlet fluid passage port through a cavity defined by the retainer. The method can include inserting at least one check valve disk having at least one valve sealing surface and biasing the at least one valve disk toward the inlet fluid passage port. The at least one valve disk can be received within the cavity for reciprocal movement with respect to the inlet fluid passage port of the body and normally biased toward the inlet fluid passage port. The at least one valve disk can be biased toward the inlet fluid passage port while allowing reciprocal movement of the at least one valve disk from a closed seated position sealed with respect to the inlet fluid passage port to an open unseated position spaced from the inlet fluid passage port allowing fluid flow through the inlet fluid passage port.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective sectional view of a hydraulic tensioner for an endless, flexible, power transmission member of an internal combustion engine of a motor vehicle having an inlet fluid passage and a check valve assembly located within the fluid passage;

FIG. 2 is a perspective sectional detailed view of the check valve assembly of FIG. 1 showing a retainer defining an outlet fluid passage in fluid communication with the inlet fluid passage through a cavity, a valve disk received within the cavity for reciprocal movement with respect to the inlet fluid passage, and a biasing member received within the cavity for biasing the valve disk toward the inlet fluid passage while allowing reciprocal movement of the at least one valve disk from a sealed position to an unsealed position spaced from the inlet fluid passage allowing fluid flow therethrough; and

FIG. 3 is a bottom view of the check valve assembly of FIG. 2 showing a valve sealing surface of the valve disk and a metered fluid passage formed in the valve sealing surface allowing a metered backflow of fluid pressure in the hydraulic tensioner.

### DETAILED DESCRIPTION

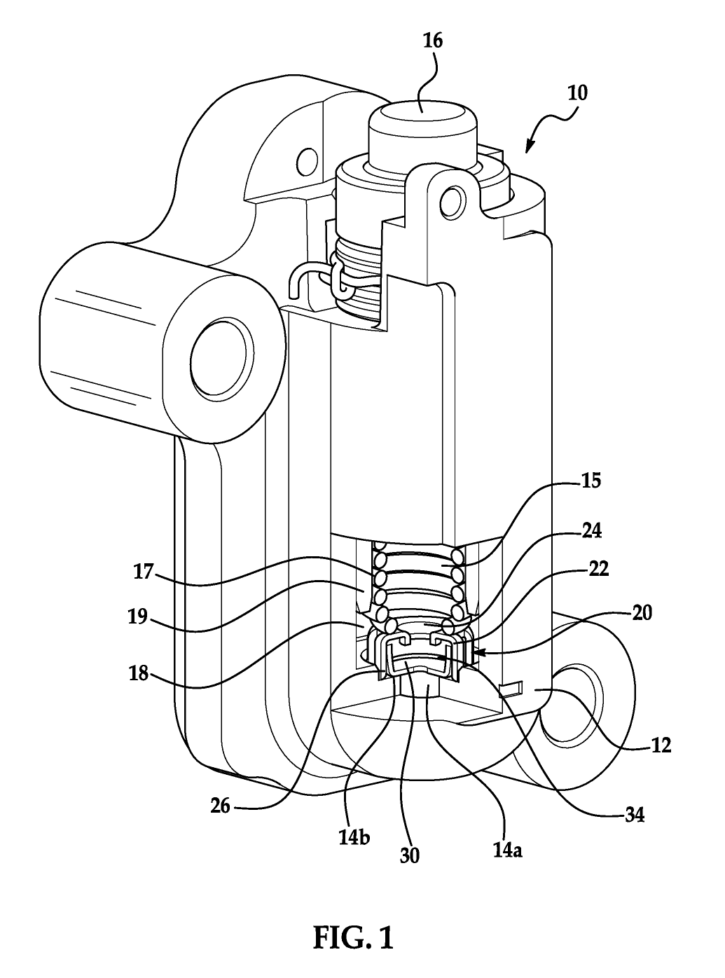

Referring now to FIG. 1, a hydraulic tensioner 10 can be used for an endless loop, flexible, power transmission member for an internal combustion engine of a motor vehicle. The power transmission member encircles a drive sprocket driven by a drive shaft, such as a crank shaft of the engine, and the at least one driven sprocket supported from a driven shaft, such as a cam shaft of the engine. In operation, the check valve assembly 20 controls the flow of hydraulic oil into a high pressure chamber of a hydraulic tensioner 10 to support a piston 16 in operable engagement with a tensioning arm to maintain tension on the power transmission member in order to remove excess slack in the power transmission member. As pressure increases beyond a check valve biasing force of at least one of at least one valve disk 30 of the check valve assembly 20, hydraulic oil flows through the check valve assembly 20 and into the high pressure chamber of the tensioner 10 as the piston 16 extends to take up slack in the power transmission member. The hydraulic tensioner 10 can include a spring 15 supported by the piston 16 within the body 12 of the hydraulic tensioner 10. The spring 15 can normally bias the check valve assembly 20 toward an inlet fluid passage defined by the body 12 of the tensioner 10. The inlet fluid passage can be in fluid communication with a fluid passage 18 defined by the 12 body of the tensioner. The fluid passage 18 can be in fluid communication with the high pressure chamber of the tensioner 10 through a body 19 of the piston 16 to extend the piston 16.

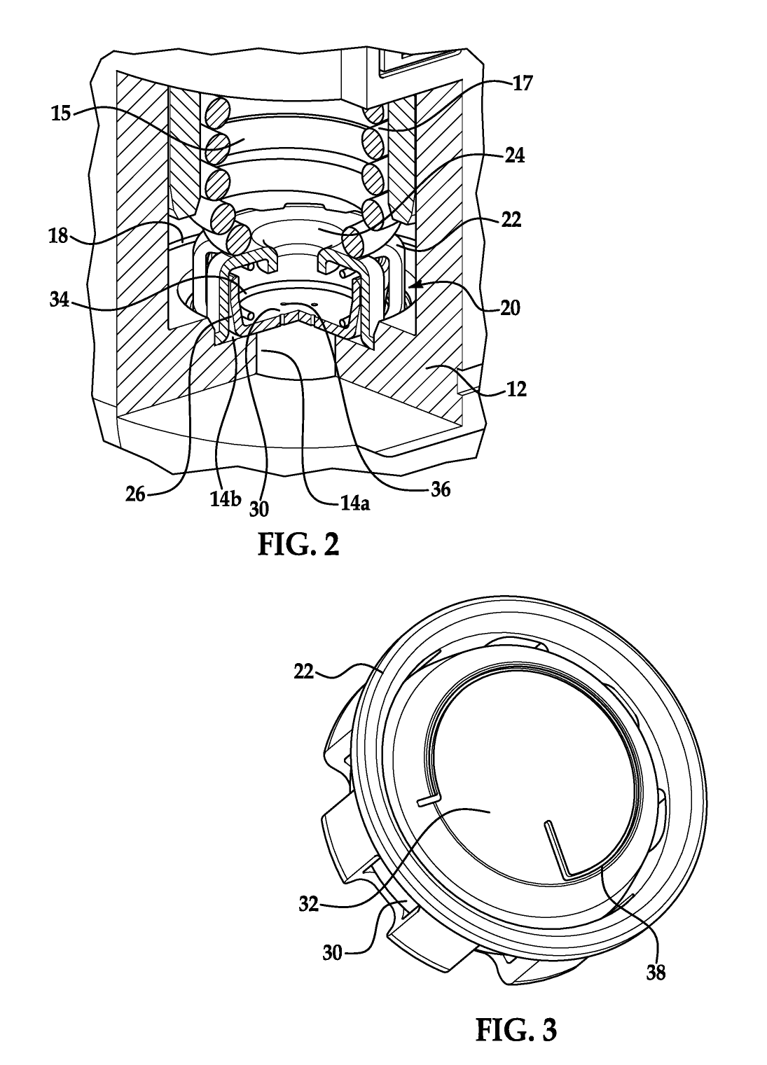

Referring now to FIGS. 1-3, the hydraulic tensioner 10 for an endless loop, flexible, power transmission member of the internal combustion engine of the motor vehicle can have a body 12 defining an inlet fluid passage with an inlet fluid passage port 14a having a valve seat 14b and a check valve assembly 20. The check valve assembly 20 can include a retainer 22 located within the body 12. The retainer 22 can define an outlet fluid passage 24 in fluid communicating with the inlet fluid passage through a cavity 26 defined by the retainer 22. The check valve assembly 20 can include at least one valve disk 30 having at least one valve sealing surface 32. The at least one valve disk 30 can be received within the cavity 26 for reciprocal movement with respect to the inlet fluid passage port 14a of the body 12 and normally biased toward the inlet fluid passage port 14a. The check valve assembly can include at least one biasing member 34 received within the cavity 26 for biasing the at least one valve disk 30 toward the inlet fluid passage port 14a while allowing reciprocal movement of the at least one valve disk 30 from a closed seated position sealing the inlet fluid passage port 14a to an open unseated position spaced from the inlet fluid passage port 14a opening the inlet fluid passage 14 and allowing fluid flow through the inlet fluid passage 14. As best shown in FIGS. 2-3, the valve sealing surface 32 can include a curved valve sealing surface extending outwardly from the at least one valve disk 30. The at least one valve sealing surface 32 can directly engage the body 12 of the hydraulic tensioner 10.

Referring now to FIGS. 1-2, the at least one valve disk 30 can include at least one orifice 36 defined in the valve disk 30 allowing a metered backflow of fluid pressure in the hydraulic tensioner 10. The at least one orifice 36 can be in fluid communication with the inlet fluid passage 14. The at least one orifice 36 can include a plurality of orifices. Each of the plurality of orifices can have a predetermined diameter. By way of example and not limitation, the at least one orifice 36 can be formed by a process selected from at least one of a metal stamping process, a deep-drawing metal forming process, a waterjet cutting process, and a laser cutting process.

Referring now to FIG. 3, the at least one valve disk 30 can include a metered fluid passage 38 allowing a metered backflow of fluid pressure in the hydraulic tensioner 10. The metered fluid passage can be formed in one of the valve sealing surface 32 of the at least one valve disk 30 and the body 12 of the hydraulic tensioner 10. The metered fluid passage 38 can be in fluid communication with the inlet fluid passage and can define a tortuous flow path. By way of example and not limitation, the metered fluid passage 38 can be formed by a process including a laser cutting process.

The check valve assembly 20 can include at least one mating surface 14b associated with the inlet fluid passage. The at least one valve sealing surface 32 can be sealingly engageable with the at least one mating surface 14b. The at least one biasing member 34 can allow reciprocal movement of the at least one valve disk 30 from a closed seated position sealing against fluid flow through the inlet fluid passage port 14a to an open unseated position spaced from the at least one mating surface 14b allowing fluid flow through the inlet fluid passage port 14a. The at least one valve seat 14b can include a metered fluid passage 38 allowing a metered backflow of fluid pressure in the hydraulic tensioner 10. The metered fluid passage 38 can be formed in the at least one valve disk 30 and in fluid communication with the inlet fluid passage 14.

A check valve assembly 20 can be assembled in a hydraulic tensioner 10. The hydraulic tensioner 10 can have a body 12 defining an inlet fluid passage port 14a and supporting the check valve assembly 20 for an endless loop, flexible, power transmission member of an internal combustion engine of a motor vehicle. The method can include positioning a retainer 22 within the body 12 and inserting at least one check valve disk 30. The retainer 22 can define an outlet fluid passage 24 in fluid communication with the inlet fluid passage port 14a through a cavity 26 defined by the retainer 22. The at least one valve disk 30 can be received within the cavity 26 for reciprocal movement with respect to the inlet fluid passage port 14a of the body 12 and normally biased toward the inlet fluid passage port 14a. The method can further include biasing the at least one valve disk 30 toward the inlet fluid passage port 14a while allowing reciprocal movement of the at least one valve disk 30 from a closed seated position sealed with respect to the inlet fluid passage port 14a to an open unseated position spaced from the inlet fluid passage port 14a allowing fluid flow through the inlet fluid passage port 14a. The method can further include forming at least one mating surface 14b associated with the inlet fluid passage 14. The at least one valve sealing surface 32 can be sealingly engageable with the at least one mating surface 14b. The at least one biasing member 34 can allow reciprocal movement of the at least one valve disk 30 from a seated sealed position to an unseated position spaced from the at least one mating surface 14b allowing fluid flow therethrough.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. In a hydraulic tensioner (10) for an endless loop, flexible, power transmission member of an internal combustion engine of a motor vehicle, the hydraulic tensioner (10) having a body (12) defining an inlet fluid passage with an inlet fluid passage port (14a) having a valve seat (14b) and a check valve assembly (20), the improvement of the check valve assembly (20) comprising:
a retainer (22) located within the body (12), the retainer (22) defining an outlet fluid passage (24) in fluid communication with the inlet fluid passage through a cavity (26) defined by the retainer (22);
at least one valve disk (30) having at least one valve sealing surface (32), the at least one valve disk (30) received within the cavity (26) for reciprocal movement with respect to the inlet fluid passage port (14a) of the body (12) and normally biased toward the inlet fluid passage port (14a); and
at least one biasing member (34) received within the cavity (26) for biasing the at least one valve disk (30) toward the inlet fluid passage port (14a) while allowing reciprocal movement of the at least one valve disk (30) from a closed seated position sealing the inlet fluid passage port (14a) to an open unseated position spaced from the inlet fluid passage port (14a) opening the inlet fluid passage and allowing fluid flow through the inlet fluid passage (14).

2. The improvement of claim 1, wherein the at least one valve sealing surface (32) further comprises:
a curved valve sealing surface (32) extending outwardly from the at least one valve disk (30), the at least one valve sealing surface (32) directly engageable with the body (12) of the hydraulic tensioner (10).

3. The improvement of claim 1, wherein the at least one valve disk (30) further comprises:
at least one orifice (36) defined in the valve disk (30) allowing a metered backflow of fluid pressure in the hydraulic tensioner (10), the at least one orifice (36) in fluid communication with the inlet fluid passage (14).

4. The improvement of claim 3, wherein the at least one orifice (36) includes a plurality of orifices, each of the plurality of orifices having a predetermined diameter.

5. The improvement of claim 3, wherein the at least one orifice (36) is formed by a process selected from at least one of a metal stamping process, a deep-drawing metal forming process, a waterjet cutting process, and a laser cutting process.

6. The improvement of claim 1 further comprising:
a metered fluid passage (38) allowing a metered backflow of fluid pressure in the hydraulic tensioner (10), the metered fluid passage formed in one of the valve sealing surface (32) of the at least one valve disk (30) and the body (12) of the hydraulic tensioner (10), the metered fluid passage (38) in fluid communication with the inlet fluid passage (14).

7. The improvement of claim 1 further comprising:
at least one mating surface associated with the inlet fluid passage (14), the at least one valve sealing surface (32) sealingly engageable with the at least one mating surface, the at least one biasing member (34) allowing reciprocal movement of the at least one valve disk (30) from a closed seated position sealing against fluid flow through the inlet fluid passage port (14a) to an open unseated position spaced from the at least one mating surface allowing fluid flow through the inlet fluid passage port (14a).

8. The improvement of claim 7, wherein the at least one valve seat (14b) further comprises:
a metered fluid passage (38) allowing a metered backflow of fluid pressure in the hydraulic tensioner (10), the metered fluid passage (38) formed in the at least one valve disk (30) and in fluid communication with the inlet fluid passage (14).

9. A check valve assembly (20) comprising:
a hydraulic tensioner (10) having a body (12) defining a fluid passage (18), the fluid passage (18) in fluid communication with an inlet fluid passage having an inlet fluid passage port (14a);
a retainer (22) located within the fluid passage (18) of the hydraulic tensioner (10), the retainer (22) defining an outlet fluid passage (24) in fluid communication with the inlet fluid passage through a cavity (26) defined by the retainer (22);
at least one valve disk (30) having at least one valve sealing surface (32) directly engageable with the body (12) of the hydraulic tensioner (10), the at least one valve disk (30) received within the cavity (26) for reciprocal movement with respect to the inlet fluid passage port (14a) and normally biased toward the inlet fluid passage port (14a); and
at least one biasing member (34) received within the cavity (26) for biasing the at least one valve disk (30) toward the inlet fluid passage port (14a) while allowing reciprocal movement of the at least one valve disk (30) from a seated, closed position sealing the inlet fluid passage port (14a) to an open, unseated position spaced from the inlet fluid passage port (14a) allowing fluid flow through the inlet fluid passage port (14a).

10. The check valve assembly (20) of claim 9, wherein the at least one valve disk (30) further comprises:
at least one orifice (36) formed in the at least one valve disk (30) allowing a metered backflow of fluid pressure in the hydraulic tensioner (10), the at least one orifice (36) in fluid communication with the inlet fluid passage (14).

11. The check valve assembly (20) of claim 10, wherein the at least one orifice (36) is formed by a process selected from at least one of a metal stamping process, a deep-drawing metal forming process, a waterjet cutting process, and a laser cutting process.

12. The check valve assembly (20) of claim 9 further comprising:
a metered fluid passage (38) allowing a metered backflow of fluid pressure in the hydraulic tensioner (10), the metered fluid passage (38) formed in one of the valve sealing surface (32) of the at least one valve disk (30) and the body (12) of the hydraulic tensioner (10).

13. The check valve assembly (20) of claim 12, wherein the metered fluid passage (38) is formed by a process including a laser cutting process.

14. A method of assembling a hydraulic tensioner (10) having a body (12) defining an inlet fluid passage port (14a) and supporting a check valve assembly (20) for an endless loop, flexible, power transmission member of an internal combustion engine of a motor vehicle, the method comprising:
positioning a retainer (22) within the body (12), the retainer (22) defining an outlet fluid passage (24) in fluid communication with the inlet fluid passage port (14a) through a cavity (26) defined by the retainer (22);
inserting at least one check valve disk (30) having at least one valve sealing surface (32), the at least one valve disk (30) received within the cavity (26) for reciprocal movement with respect to the inlet fluid passage port (14a) of the body (12) and normally biased toward the inlet fluid passage port (14a); and
biasing the at least one valve disk (30) toward the inlet fluid passage port (14a) while allowing reciprocal movement of the at least one valve disk (30) from a closed seated position sealed with respect to the inlet fluid passage port (14a) to an open unseated position spaced from the inlet fluid passage port (14a) allowing fluid flow through the inlet fluid passage port (14a).

15. The method of claim 13 further comprising:
forming at least one mating surface associated with the inlet fluid passage (14), the at least one valve sealing surface (32) sealingly engageable with the at least one mating surface, the at least one biasing member (34) allowing reciprocal s movement of the at least one valve disk (30) from a seated sealed position to an unseated position spaced from the at least one mating surface allowing fluid flow therethrough.
